(19) United States
(12) Patent Application Publication
(10) Pub. No.: US 2018/0338187 A1
(43) Pub. Date: Nov. 22, 2018

(54) ADVANCED WI-FI PERFORMANCE MONITORING

(71) Applicant: 7signal Solutions, Inc., Akron, OH (US)

(72) Inventors: Veli-Pekka Ketonen, Aurora, OH (US); Eric I. Camulli, Copley, OH (US); Jeffrey W. Reedy, Durham, NC (US)

(21) Appl. No.: 15/600,649

(22) Filed: May 19, 2017

(51) Int. Cl. H04N 21/647; H04L 12/26; H04L 29/08; H04W 24/08

(52) U.S. Cl. CPC H04N 21/64738; H04L 43/0876; H04L 43/0888; H04W 4/02; H04W 24/08; H04N 21/6473; H04N 21/64723; H04L 67/10

(57) ABSTRACT

A system and method for advanced Wi-Fi performance monitoring, comprising an agent application operating on a mobile device in background operation to monitor device state and operation and test network performance during ideal times, and that presents results in an easy-to-read single-page user interface for data viewing. Test results may be logged in a database and shared across devices to enhance their own test data by filling in missing information, and may be used to form a broad representation of network performance that may be used to notify devices of performance issues or outages.

### CROSS-REFERENCE TO RELATED APPLICATIONS

None.

### BACKGROUND OF THE INVENTION

### Field of the Art

The disclosure relates to the field of networking technology, and more particularly to the field of monitoring and testing performance of Wi-Fi networks.

### Discussion of the State of the Art

In the field of networking, it is often important to be able to check the performance of a network or a device on a network without stopping or interfering with other operations. On mobile devices this can be a challenge, both due to the unique usage models involved and the rapidly-roaming nature of the devices on multiple networks throughout the day. Existing solutions require a user to run manual network performance tests, and results are often difficult to decipher or offer no meaningful insights that may be used to improve performance.

What is needed, is a way to monitor network performance in the background on a mobile device, that considers the device state and activity when determining whether or how to test performance, and that produces meaningful results that can aid a user in network diagnostics.

### SUMMARY OF THE INVENTION

Accordingly, the inventor has conceived and reduced to practice, in a preferred embodiment of the invention, a system and method for advanced Wi-Fi performance monitoring.

The embodiments herein describe the use of an agent application operating on a mobile device in background operation to monitor device state and operation and test network performance during ideal times (generally when the device is not under load or is not being actively used by the user, or when triggered by a hardware sensor condition), and that presents results in an easy-to-read single-page user interface for data viewing. Test results may be logged in a database and shared across devices to enhance their own test data by filling in missing information, and may be used to form a broad representation of network performance that may be used to notify devices of performance issues or outages.

According to an aspect, a software agent on a mobile device performs tests of a wireless network, operating in the background without user interaction, and sends tests results to a central server. The agent contacts a test configuration server before each periodic test to determine what tests need to be performed and how often, or when, the next test need to be performed. After loading the latest required test profile, the agent performs the tests. According to an aspect, the agent activates tests after a certain period of idle time of the mobile device/computer. When the mobile device/computer is unused (e.g., locked, and/or not active continuously running applications), the agent performs tests more frequently, or performs more detailed tests. These periodically (and typically for short periods) disconnect the device radio from the wireless network for the test, returning connection immediately after completion of the test. If the mobile device/computer is activated (e.g., a motion sensor detects movement, a screensaver is stopped, or a computer is unlocked), or an application activates, idle time testing is halted.

According to an aspect, a software agent on a mobile device or a computer runs an active test against a test end point. This first segment test triggers another test from the first test end point towards another, second test end point (segment 2). This in turn may trigger yet another test towards yet another end point (segment 3). Results of these individual segment tests are returned back to the agent. The agent gets information for performance over the wireless and potentially also within wired networks between the test end points. This allows segmenting or testing performance of wired networks without sensors. Test end points (e.g., a small appliance or virtual machine service) with the capability to support the tests are needed, but they are few compared to sensors.

According to an aspect, an agent running a test triggers a packet capture at a network tap device connected to one of the switches or routers associated with a network. The agent runs a test with a specific traffic pattern, or other indication, to a passive network tap device observing traffic passing the host switch or router. Once the tap is triggered, it observes traffic from the device hosting the agent. Traffic measurement results (observed load, throughput, jitter, packet loss, etc.) from the tap are sent back to the device hosting the agent. The agent submits the data to a central server.

According to an aspect, active testing is carried out with an additional radio. An agent host device includes another radio which can be used for testing without interrupting traffic in the main active radio. As an example, this could be an additional USB Wi-Fi dongle plugged into a computer. This radio device performs active tests through nearby APs without interrupting the device main radio connectivity (i.e., the principal onboard Wi-Fi network adapter of the device). According to a related aspect, passive testing may also be conducted using an additional radio. The agent host device includes another radio which can be used for testing without interrupting traffic in the main active radio. As an example, this can be additional USB Wi-Fi dongle plugged into a computer. This radio device passively collects signal information from surrounding APs, passively run packet captures on different channels to determine characteristics of the traffic (air utilization, retransmissions, quantities of specific types of packets, etc.). The agent may also passively monitor transmissions of the main radio of the same host device and collect data which may not be available from the driver of that radio card (like retransmissions, MCS distribution, radio traffic volume).

According to an aspect, static locations of devices without location service may be used in testing. An agent in a device without location capability (i.e., no GPS or other location service is supported in the device) gets a predefined location from a configuration server and submits this location together with the test result data. This predefined location may be for example a hospital building with certain floor for devices used always in one ward. In a related aspect, dynamic location determination may be performed, dynamically determining location based for example on wireless signal characteristics for a client device without location capability (i.e., no GPS or other location service is supported in the device).

According to an aspect, a method to determine offline access points (APs) from test agent data. Agents scan APs (BSSIDs) and their signal levels. This information may be submitted to a central server. The central server monitors reported signal levels. If an earlier measurement indicated similar signal levels for all APs, but a specific AP is missing completely, this indicates the specific AP is offline. A notification or alarm may be triggered.

According to an aspect, an agent performs active tests over a single SSID, the test traffic including an ID which indicates to which VLAN the test traffic is expected to be routed outside the wireless network. Tests over the different VLANs are reported separately.

According to an aspect, agents operating on mobile devices or computers may continuously monitor wireless network conditions (for example, but not limited to, monitoring the BSSID used and its signal level, monitoring neighbor BSSIDs and their signal levels, monitoring GPS coordinates, monitoring velocity of a mobile device, etc.). According to the aspect, agents receive test instructions, which may trigger a test in the presence of defined conditions. For example, a specific BSSID may need to be tested in more detail; when clients are connected to that BSSID, tests may be run more often or more tests may be performed.

According to an aspect, an agent observes dynamic frequency selection (DFS) events and reports them. Agents may use host device radio to detect presence of radars. Agents may also observe messages from an AP which indicate that the AP has detected a radar. DFS information thus may be collected and reported as part of a wireless networking test program.

According to a preferred embodiment, a system for advanced Wi-Fi performance monitoring, comprising: a network testing device comprising: a processor; a memory; a plurality of programming instructions stored in the memory and operating on the processor; a plurality of hardware network interfaces; wherein the programming instructions are configured to operate a client agent application that sends and receives information packets via at least one of the hardware network interfaces, using a background process that is configured to listen for information packets without impacting other operations on the network testing device; wherein the information packets comprise at least a notification event and a plurality of test packets; and wherein the client agent application is configured to perform a test execution comprising at least the measurement of a plurality of network performance statistics based at least in part on the transmission and receipt of at least a portion of the test packets, is disclosed.

According to another preferred embodiment, a method for advanced Wi-Fi performance monitoring, comprising the steps of: receiving, at a network testing agent device, a notification event via a network interface; transmitting a plurality of test packets; receiving a plurality of response test packets; and recording the results of the transmission and receipt of the test packets, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary system architecture for advanced Wi-Fi performance monitoring, according to a preferred embodiment.

FIG. 2 is a flow diagram illustrating an exemplary method for advanced Wi-Fi performance monitoring, illustrating an overview process for triggering a background performance test, according to a preferred embodiment.

FIG. 3 is a block diagram illustrating an exemplary embodiment for advanced Wi-Fi performance monitoring, illustrating multiple zones within a floor of a building.

FIG. 4 is a block diagram illustrating an exemplary embodiment for advanced Wi-Fi performance monitoring, illustrating multiple floors within a building.

FIG. 5 is a block diagram illustrating an exemplary hardware architecture of a computing device used in an embodiment of the invention.

FIG. 6 is a block diagram illustrating an exemplary logical architecture for a client device, according to an embodiment of the invention.

FIG. 7 is a block diagram showing an exemplary architectural arrangement of clients, servers, and external services, according to an embodiment of the invention.

FIG. 8 is another block diagram illustrating an exemplary hardware architecture of a computing device used in various embodiments of the invention.

FIG. 9 is a flow diagram illustrating an exemplary method for determining offline access points using a client agent.

### DETAILED DESCRIPTION

The inventor has conceived, and reduced to practice, in a preferred embodiment of the invention, a system and method for advanced Wi-Fi performance monitoring, that utilizes background operation to test network performance during ideal times on a user's mobile device, and presents results in an easy-to-read single-page user interface for data viewing.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Conceptual Architecture

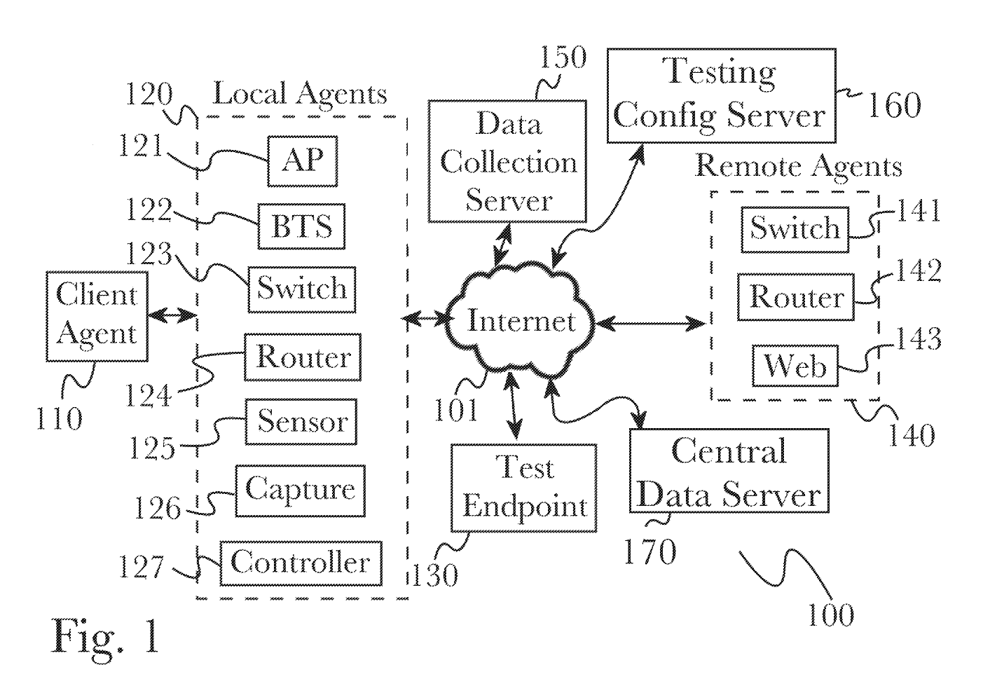

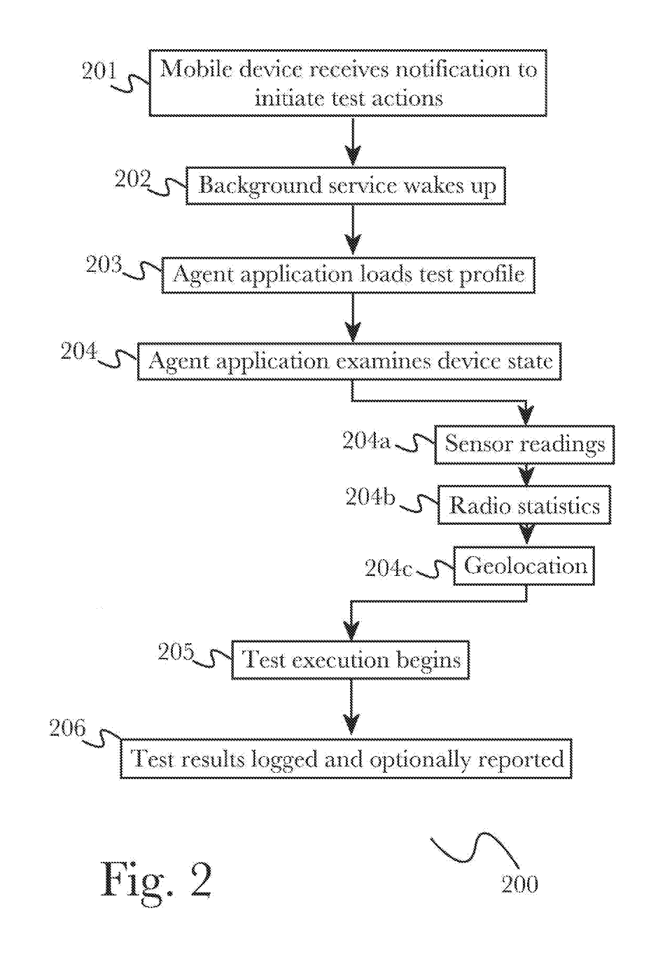

FIG. 1 is a block diagram illustrating an exemplary system architecture 100 for advanced Wi-Fi performance monitoring, according to a preferred embodiment. According to the embodiment, a client agent 110 may be a software application configured to run on any of a variety of computing devices such as a laptop personal computer, smartphone, tablet computing device, wearable computing device, or other such device types, and is configured to operate as a testing client during interactions with other agent applications via a network connection. Client agent 110 may communicate via a local network connection, such as a Wi-Fi network, to communicate with a variety of local agents 120, or the Internet 101 to communicate with remote agents 140 such as switch 141, router 142, web 143, or other agents operated by cloud-based service providers or on remote servers (for example, networking hardware operating at a remote location using a switch 141 or router agent 142 for purposes of testing, or a web server operating a web agent 143 accessible via the Internet, or other arrangements). A test endpoint agent 130 may be a personal computer or a server operated by a third-party (for example, a testing service offering the use of servers for purposes of the methods described below), which may be used to test end-to-end network performance between test endpoint 130 and client agent 110 as needed, according to the specific nature of a particular test being performed. A data collection server 150 may be used to collect testing data for use in crowdsourced information sharing (for example, to show results of tests performed by other client agents, or to form a heatmap or coverage map representation of aggregated testing results). A controller agent 127 may be used to provide remote triggering for test operations, for example by transmitting a push notification to a user's mobile device which is then received by a running test agent software application on the device (as described below, referring to FIG. 2). Various networking hardware may also be used in testing by running an agent application configured for that particular device or device type, for example a network access point (AP) 121, cell network base transceiver station (BTS) 122, switch 123 or router 124, that may be used to test performance between client agent 110 and the network hardware agent, which may be used to facilitate a variety of local tests that do not necessarily require an external connection to the Internet or an external server. Data collection server 150 may store and provide test results for use, such as for presentation via the agent application operating on client agent 110, as well as to incorporate various historical test data into current or future tests. For example, a user may perform tests on two client agents 110, and each device may update its known test data using results from the other device's tests, enabling shared test data to form a more complete model of a network's performance.

According to the embodiment, a user's mobile device may run a client agent 110 software application in local memory, that remains active silently while the device is in use. This may be optionally in the foreground (that is, the application that a user is currently running on the main screen of their device), or it may run in the background (that is, minimized or out of view while other software is being run or actions performed on the device). While running, client agent 110 may monitor wireless networking quality parameters and, for example, adjust timing or retry rates of test activities, as well as data rates (such as MCS data rates in some arrangements), in order to optimize wireless performance and to minimize impact on the wireless network of the monitoring and testing activities, for example to avoid disrupting other devices on the wireless network.

Client agent 110 may utilize a device's notification service to trigger tests, utilizing existing background notification functionality common in mobile devices. Generally, this functionality is used to provide small amount of data to applications that need frequent updating, such as news readers or email clients, but by utilizing this notification service the agent application can remain in the background of a device with minimal usage of system resources, and when a notification event is received (for example, from a testing endpoint triggering a test remotely, or as a generated event such as by a time-based or usage-based test configuration) the application then “wakes up”, processing the event and performing test actions if appropriate. For example, the agent application may monitor device usage while in the background, such as by receiving sensor data from hardware sensors (for example, accelerometer or geolocation data) or by monitoring system resource load (such as CPU or memory usage) to determine when a device is not being actively used. When a device is not in use, a notification vent may be produced to wake up the agent app, using minimal system resources to perform a small task such to execute a network test action and log the results. These logged results may then be viewed later as a user-friendly single-page interface, that may comprise the foreground screen of the agent app (that is, when a user is running the agent in the foreground, they always see the readout of test results, and no interaction or modification is required).

Client agent 110 does not necessarily need to operate on a mobile device such as a smartphone or tablet computing device, and may run on any of a variety of networking-capable computing device including a personal computer, internet of things (IoT) device or other embedded device, networking hardware such as a router or switch, or other device types. Additionally, hardware capabilities may be added to a device to enhance functionality of a client agent 110, such as using a portable or “luggable” compact Wi-Fi adapter for a laptop personal computer to add an additional network interface specifically for monitoring and testing network performance while the computer's primary network interface remains available for a user to interact normally. Another example may be an adapter that can utilize a phone connection, for example via personal computers capable of using a telephone connection or mobile network, or for use with a mobile phone, that can give enhanced monitoring capability to devices that may ordinarily be limited (for example, radio functions in mobile devices are often restricted by manufacturers or network carriers, but this may be overcome using an additional hardware device to make additional operations available for testing purposes).

A network being monitored or tested may comprise one or more service set identifiers (SSIDs), each representing an access point (AP), and each SSID may further comprise a plurality of virtual local area networks (VLANs), enabling complex network layouts to be operated by a single AP. For example, rather than maintaining a large arrangement of AP hardware, a single AP can operate multiple VLANs to separate subnetworks such as to separate business and guest users and restrict traffic types, for example to allow guests access to the Internet but not to internal resources, while allowing business users access to internal resources such as networked printers, databases, servers, or other resources, while restricting external access via the Internet. Traditionally, this is accomplished using separate SSIDs, for example a router may operate two separate Wi-Fi networks “CompanyNetwork” and “CompanyNetwork_Guest”, which must be joined individually and generally cannot be joined simultaneously. Additionally, this consumes additional “airtime” with SSID identification packets, reducing overall capacity for connected devices. Instead, by operating multiple VLANs with a single SSID, network load is reduced and devices can optionally be load-balanced across VLANs.

A variety of test actions and test types are possible according to the embodiment, according to various network and device configurations or capabilities, or the configuration of the agent application, or the contents of a particular notification event. Tests may be performed using various combinations of network-connected devices, for example between mobile device 110 and router 124, test endpoint 130, or another mobile device 110 such as to test performance between two client devices on the same network, or to perform more advanced test actions using (for example) a smartphone and a personal computer. Test actions may include (but are not limited to) basic network testing such as packet transmission to test packet loss or travel time, upload and download performance statistics, payload-based throughput tests, voice quality testing for voice over internet protocol (VoIP) applications, or packet capture that may involve a capture agent 126 that operates as a “tap” on a network connection, listening to and capturing sent packets from client agent 110 and returning test results after completion (this may be used to check packet integrity or detailed packet loss statistics, for example), or sensor-based tests such as using a smartphone's hardware sensors to select and perform test actions (for example, picking a specific cellular radio band to use based on device hardware measurements). Geolocation information may be used to map network access points (APs) such as routers, modems, or cell towers, and this location information may be used to identify and select APs during tests and in test reporting, for example by including coordinates or human-readable location names in test data alongside other test information such as radio channels, bands, or signal strength, or the location of the client agent 110 when the test was performed (as may be derived from onboard hardware sensors). This may also be used in the selection of test actions to perform, such as to select an AP or a wireless band based on known location or distance, for example to confirm whether real network performance matches what is expected given the location of the AP relative to the agent. In a mobile device that may have multiple network connection interfaces (for example, Wi-Fi and cellular radios), one interface may be used for testing while another remains active for other device operations, enabling an otherwise unused interface to be used to monitor performance in the background as the device continues normal operation. Additionally, performance readings may be compared across multiple interfaces, channels, bands, or frequencies to increase granularity of test result data, according to a testing protocol. Another use may be to measure dynamic frequency scaling (DFS) events, checking for radar signals and automatically determining how to optimize network setup around possible radar activity by monitoring DFS channel activity and utilizing these (ordinarily unused) channels when possible.

Test result reporting may comprise a variety of additional information as well as the results of a particular test action, such as ping response time, packet loss ratio, signal strength reading, or other such network statistics. Additional information may comprise (for example, including but not limited to) a variety of location-based information such as the location of the client agent 110 when the test was performed, location of an AP used during the test, hardware sensor readings from a mobile device at the time of the test, synchronized test data from other devices or previous tests (for example, when testing a single network using multiple agents), or any other additional information that may be relevant to a network, device, or test. Additionally, reporting may vary based on the particular device configuration, with more capable agents (such as personal computers with more system resources at their disposal) providing more information or a finer granularity, and less-capable devices (such as mobile phones with limited resources, or devices where the software configuration limits functionality) reporting within their capabilities. Synchronized data from other devices or a test database may be used to augment test results, for example by filling in gaps in information when needed. For example, if a mobile device is set to forbid location sharing (or lacks the hardware capability), known location information for an access point to which the device is connected may be provided instead.

Controller agent 127 may be used to send notifications to a client agent 110 to trigger test actions, for example for network tests involving an Internet connection (such as tests to a remote test endpoint 130) that may be triggered based on time intervals or other conditions independent of client agent 110 (as opposed to, for example, triggering on sensor data as described previously). Additionally, controller agent 127 may send a test protocol that comprises a plurality of test actions and configuration, for example to both trigger a test and tell the receiving device exactly what test actions to perform, and may also send a non-test notification (that is, a message notification for viewing by a user) to alert of network issues that have been previously detected or reported, for example based on a mobile device's location information and stored historical test results in a data collection server 150. This may be used to turn individual tests into data for a crowdsourced network reporting arrangement, wherein every test performed contributes to a publicly-available pool of information that may be used to alert users of outages or issues, as well as provide meaningful network information in a manner similar to a coverage map (this may be particularly useful in areas with a large number of public access points, such as metro Wi-Fi networks or public hotspots). In some arrangements, controller agent 127 may utilize machine learning to automatically select and configure test protocols based on historical testing data, for example performing additional tests based on the results of a previous test to confirm whether performance has improved or if other devices are detecting similar performance (to confirm an outage, for example).

A sensor agent 125 may be a dedicated hardware device operating an agent application, or a repurposed or recycled network device such as a router or switch that is no longer being used in its primary role. For example, a router may be connected as a client to a network being run by another router, and may operate a sensor agent 125 application to be used in network performance testing and monitoring. Sensor agent 125 uses may include a variety of network-based tests and measurements such as ping times, packet loss, and other various network metrics, and according to the particular nature of the device hardware may also include location-based sensor data such as via network triangulation, BLUETOOTH™ beacon operation, geolocation sensors such as GPS or GLONASS, or other ways of identifying a device location (either globally or within a network or local area specifically). This sensor data may be used both as a test endpoint (wherein a client agent 110 performs network tests by communicating directly with the sensor agent 125), or it may be used to enhance other test information such as to apply known location information to historical test results or to enhance current tests by providing an additional data source or additional data points or types for collection.

Network performance testing may make use of idle machines on a network, running tests and monitoring network performance during idle time when devices may be powered on but unused (or underused, as they may be performing other idle or background tasks during downtime). This enables passive monitoring and testing of a network any time a device is not being actively used by a user, collecting information and optimizing performance without impacting user operations or requiring any direct action or configuration.

An additional use of background notification-based performance monitoring, is the ability to implement this functionality in existing applications in a manner that is fully transparent to a device user. For example, an application with which a user is interacting (for example, a browser, news reader, game, email client, or any other of a wide variety of software that may operate on a mobile device) may operate a background service that monitors network performance and device state, silently providing the test capabilities described herein. This can be used in various applications, such as in a point-of-sale (POS) setup to ensure the network performance is adequate for business operations, or in IT to ensure the network can handle a client's needs.

A client agent 110 may perform tests in the background without requiring input from a user or affecting other device or software activities, and may send testing results to a centralized server 150 for storage and future reference. A server 150 may also be used to store and provide configuration information that may be retrieved by, or received at, client agent 110 to direct operation or enhance test information with additional data, such as (for example, including but not limited to) adding geolocation data from a stored database of known location information when no geolocation sensors are available, or detecting offline APs by comparing detected APs from scanning against a list of known APs that should be within range. Configuration information may be collected based on timer information, for example loading test configurations at intervals to run scheduled tests. Timer information may also be used to activate tests based on a detected idle time for client agent 110, such as when a user is not using their device. If activity is resumed, a test may be either paused or ended (and any results handled appropriately), so as to not affect user activity. In some aspects, test execution is managed or controlled by a test configuration server 160, which may provide test configuration data to client agents 110 periodically, when requested, or upon occurrence of one or more specific events (for example, test events such as a test that fails, or operational events such as a change of wireless access point being used by client agent 110. Similarly, while data collection server 150 may be used to collect test data, in some aspects a centralized wireless testing server 170 may be used to manage test execution in real time (for example, by receiving a request from a client agent 110 for a list of tests to perform, when client agent 110 detects that the network testing device on which it resides is idle), and for receiving test result data from a plurality of client agents 110 resident on a plurality of network testing devices 120. Furthermore, according to various aspects central wireless testing server 170 may compute operational parameters of various wireless or wired networks based on test results received from a plurality of client agents 110, and may direct one or more client agents 110 to carry out additional tests based on those operational parameters.

Client agent 110 may run a test against a test endpoint 120, 130, 140, that may then trigger an additional test between the current endpoint and another test endpoint, in a segmented or chain-like fashion. Results from each test segment may then be reported back to client agent 110 and compiled for final analysis or storage. Tests may be used to trigger actions on a test endpoint, such as to activate a network traffic tap or logger operated by a network endpoint 140, which may monitor or analyze network performance and send results to client agent 110. In devices with multiple network interfaces or radios, testing may take place using one or more interfaces while leaving at least one interface for user activities, for example in a mobile phone on a Wi-Fi network wherein a user may continue using their device and using the Wi-Fi connection, while tests may be performed using an idle cellular radio network interface. This may also be performed in a passive modality, wherein test configuration, response packets, or other data may be received via additional network interfaces, monitoring and collecting information via unused interfaces without impacting user activity. When performing tests over a particular network SSID, test packets may include ID information identifying a particular VLAN operated by the network AP, enabling testing and reporting of individual VLANs separately. Various network or device conditions may be continuously monitored by client agent 110, such as (for example) a known BSSID and its signal level, location or movement, neighboring BSSIDs and their signal levels, or other such information. This may be used to trigger tests based on conditions such as when a certain BSSID's signal level drops below a defined threshold, or if a BSSID begins moving, performing additional or more frequent tests based on the number of connected clients, or other such conditions.

### Detailed Description of Exemplary Embodiments

FIG. 2 is a flow diagram illustrating an exemplary method 200 for advanced Wi-Fi performance monitoring, illustrating an overview process for triggering a background performance test, according to a preferred embodiment. In an initial step 201, a notification is received by the running agent background service on mobile device 110, initiating a test. This triggers the testing service to wake up 202, optionally using a hybrid wake protocol combining the receipt of a notification with additional criteria to trigger (such as a significant change in the device's location, or resource usage thresholds it must fall under). In some arrangements, the test may wake up and execute even while a user is using another application on the device 110, for example so that testing may continue on devices that are used frequently but may have the additional resources to perform the tests without impacting the user experience. In a next step 203 a test profile may be loaded to determine the configuration of the test actions to be performed, optionally either from an on-device configuration within the agent application or a profile received from a remote source such as web server 120 sending a test profile along with the initial notification for execution. In a next step 204, the agent application may compare the current state of mobile device 110 against the test protocol to determine whether to execute the test, for example checking sensor data 204a to ensure the device is capable of performing the necessary actions, radio data 204b to determine a specific network radio or frequency band to use for the test, or location data 204c to determine whether the device has moved significantly since a previous test (to see if the current test is needed or will be relevant, for example) or to select an appropriate access point based on known location information. In a next step 205, the test begins execution, performing actions as directed by the testing protocol such as packet transmission, signal strength measurements, communication with remote resources such as web server 120 or a third-party test endpoint 122 (for example, a webpage or remote server), or other actions that may be used to measure network performance, and in a final step 206 the test results are logged and optionally reported to web server 120 for storage in a testing database 130 for future reference.

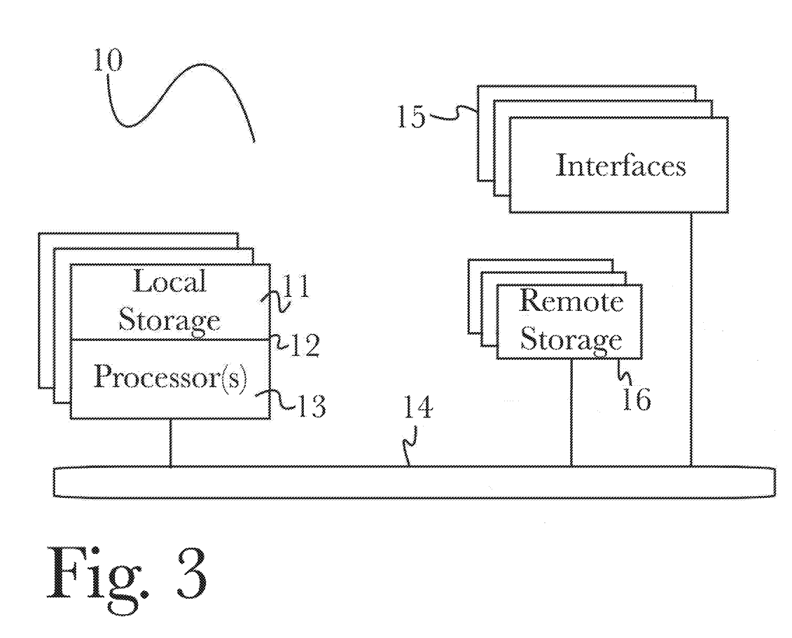

FIG. 3 is a block diagram illustrating an exemplary embodiment for advanced Wi-Fi performance monitoring, illustrating multiple zones 310, 320 within a floor 300 of a building. According to the embodiment, a client agent 110 operating on a device such as a smartphone or a personal computer (for example, either using an integrated network interface or using a luggable network adapter) may be used to connect to Wi-Fi networks or zones within a single network to test performance in different areas of a building and check line-of-sight (LOS), for example to check dead zones or areas where reception can be improved or interference can be reduced. Client agent 110 can perform a variety of tests with an agent application running on an AP 311, 321, such as packet loss, response time, bandwidth, or other performance tests, and tests may be performed and retried while client agent 110 moves around within and between network zones 310, 320 to examine the changes in test results. AP location information can be incorporated into results as described previously, allowing a location-based map or other representation to be formed from test results and determine network optimization information for floor 300.

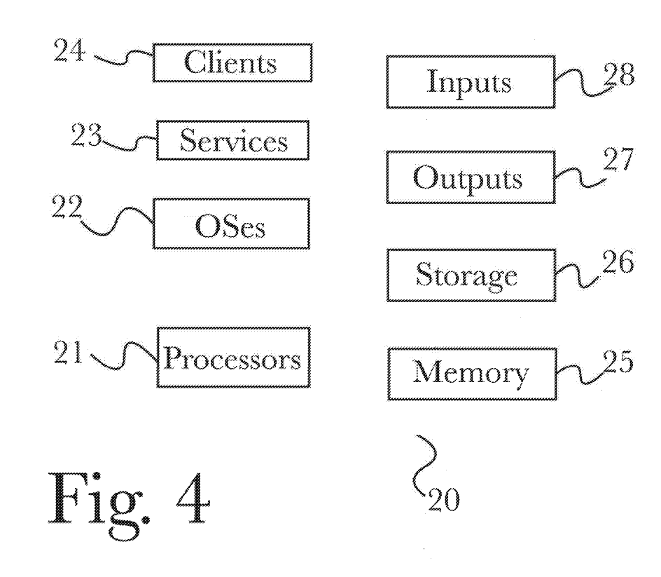

FIG. 4 is a block diagram illustrating an exemplary embodiment for advanced Wi-Fi performance monitoring, illustrating multiple floors 410, 420, 430 within a building 400. According to the embodiment, a client agent 110 may be used to perform network tests with multiple APs 412, 432 to monitor network performance within a building 400 in a multiple-floor setup with more than one network or network zone 411, 431, similar to monitoring network zones within a single-floor arrangement as described above (referring to FIG. 3). Client agent 110 may be used to identify areas with gaps in network reception 440 where no AP is reachable, or to determine radio performance statistics through the floors to identify ways to improve performance by optimizing AP placement or layout of other features on each floor to reduce interference and improve LOS between devices and APs.

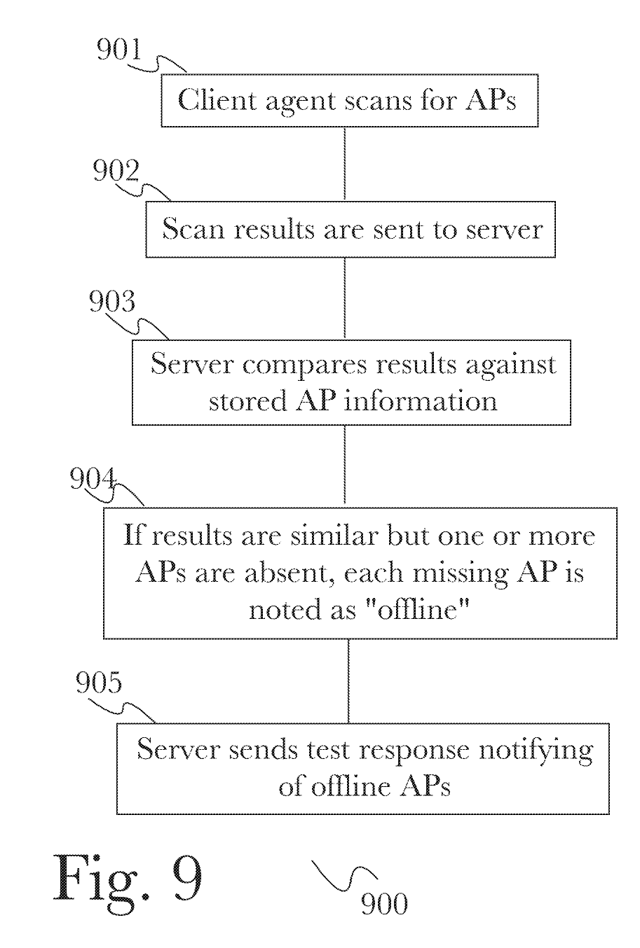

FIG. 9 is a flow diagram illustrating an exemplary method 900 for determining offline access points using a client agent. In an initial step 901, a client agent 110 may scan for network APs (BSSIDs) and their signal levels. This information may then be submitted 902 to a centralized testing storage server 150. Server 150 may observe reported signal levels 903, and if an earlier measurement indicated similar signal levels for all APs, but one AP is missing completely, this may be used to infer 904 that the missing AP is offline. In a final step 905, a test response packet is sent, which may comprise reporting information notifying of the offline AP, or may be used to trigger a notification or alarm.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

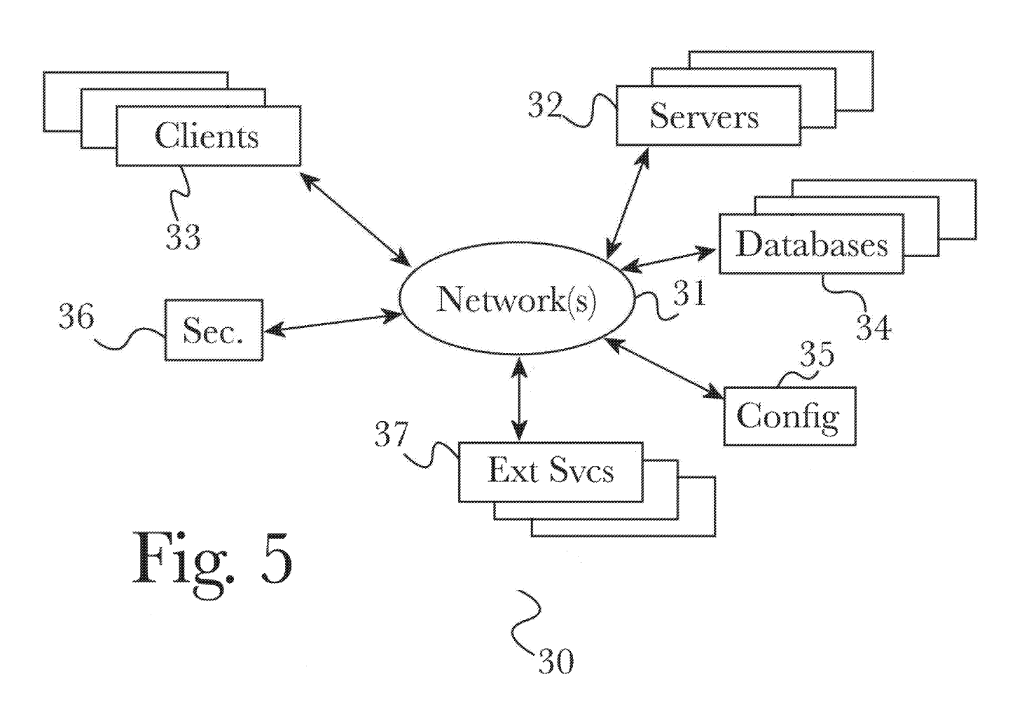

Referring now to FIG. 5, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 5 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

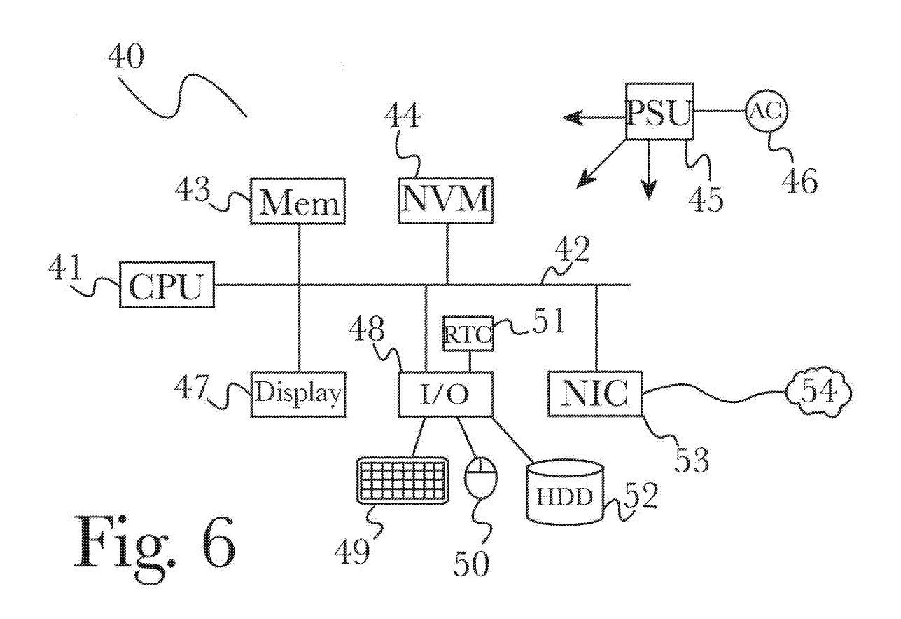

In some embodiments, systems according to the present invention may be implemented on a standalone computing system. Referring now to FIG. 6, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 5). Examples of storage devices 26 include flash memory, magnetic hard drive, CD-ROM, and/or the like.

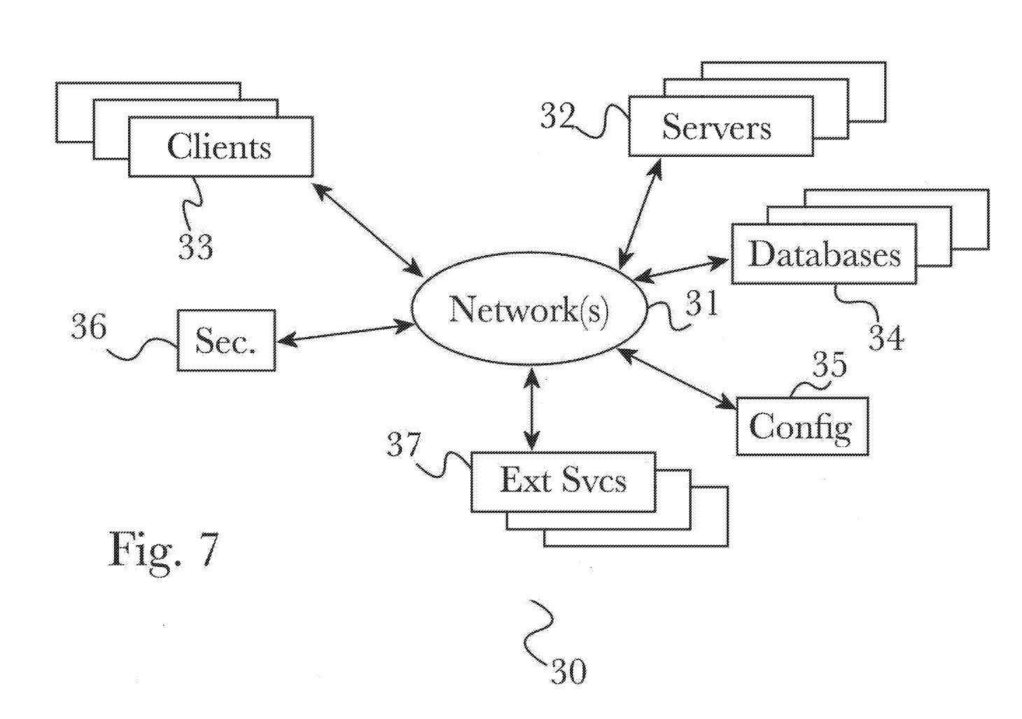

In some embodiments, systems of the present invention may be implemented on a distributed computing network, such as one having any number of clients and/or servers. Referring now to FIG. 7, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 6. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

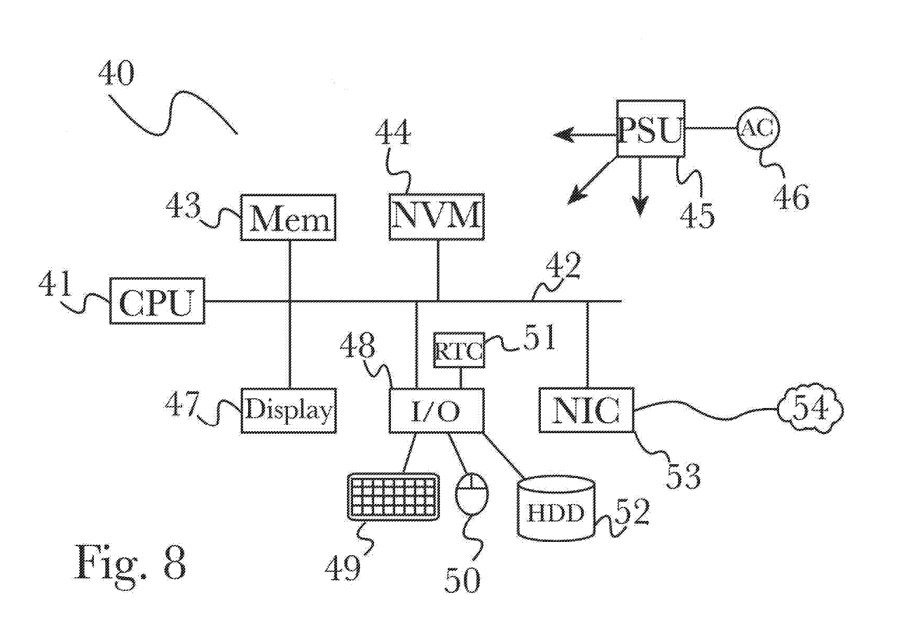

FIG. 8 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

It will be appreciated that many variations are possible, and that many wireless networking testing capabilities may be provided by systems or according to methods of inventions described herein. For example, advanced wireless network monitoring capabilities may include multiple endpoints, where a test ending from one to another triggers the next segment test; results may fall back to originator. Some aspects may use more capable device data to collect channel and other data and return that data to a less capable device to show as a test result. Preprogrammed locations may be used for no-location-allowed clients. Some aspects may dynamically trigger tests if conditions are met (e.g., location, BSSID, etc.). Some aspects may use third radio (USB) in a mobile device or computer for testing. Some aspects may test a single AP vs several VLANs, and may cause traffic to route differently as a result. An aspect may trigger tap capture from a software agent. Some aspects may use idle machines to run tests (actively or passively, or both). Passive monitoring of users may be conducted according to an aspect. Some aspects may pull a test profile at the start of each test period. Roaming concepts such as using AP names that include coordinates, using beacons include AP coordinates, providing stickiness, using band select techniques, forcing agent disconnect in some conditions, triggering tests using motion sensors or GPS data, sensing current use case (e.g., device in pockets, desks, etc.), and testing accordingly. Some aspects may use AP BSSIDs to allocate APs to service areas and to report them.

The skilled person will be aware of a range of possible modifications of the various embodiments described above. Accordingly, the present invention is defined by the claims and their equivalents.

What is claimed is:

1. A system for advanced Wi-Fi performance monitoring, comprising:
a network testing device comprising a processor, a memory, a first wireless network interface, and a plurality of programming instructions stored in the memory and operating on the processor, wherein the programming instructions, when operating on the processor, cause the processor to execute a software test agent that:
operates a wireless test agent application in background mode;
monitors data packets received by the wireless network interface;
sends a test data packet via the wireless network interface;
receives a response data packet associated with the test data packet;
determines an indicia of wireless network quality by analyzing the monitored data packets and the response data packet; and
sends a test result via the wireless network to a central wireless testing server.

2. The system of claim 1, wherein the client agent is configured to connect to and receive test instructions from a test configuration server prior to the start of a test.

3. The system of claim 1, wherein the client agent is further configured to monitor idle time on the network testing device, and the operation of the client agent is based at least in part on the idle time.

4. The system of claim 3, further wherein the client agent increases test frequency or complexity when it detects that the network testing device is not in use other than for testing.

5. The system of claim 4, wherein the client agent disconnects the network testing device from the wireless network for a specific test during an idle period, and reestablishes a wireless connection upon completion of the specific test.

6. The system of claim 1, further comprising a plurality of test endpoints, wherein:
the agent client runs a first active test against a first test end point;
the first active test triggers the first endpoint to run a second active test against a second endpoint;
the first and second test endpoints send results of the first and second active tests to the agent client;
the agent client determines a plurality of network performance indicia for a plurality of network segments based on the results of the first and second active tests; and
the agent client reports the network performance indicia for the plurality of network segments to the central wireless testing server.

7. The system of claim 1, wherein the agent client triggers a packet capture at a network tap device connected to a network element.

8. The system of claim 7, wherein the agent client runs a passive monitoring test with a specific traffic pattern using the network tap device, wherein the passive monitoring test captures traffic from the network element to the network testing device and sends test results back to the agent client.

9. The system of claim 1, wherein the network testing device comprises a second wireless network interface, wherein the client agent performs active tests through nearby wireless access points using the second wireless network interface.

10. The system of claim 1, wherein the network testing device comprises a second wireless network interface, wherein the client agent passively collects signal information from surrounding wireless access points using the second wireless network adapter.

11. The system of claim 10, wherein the client agent passively runs packet captures on a plurality of channels to determine one or more of air utilization, retransmissions, and a quantity of a specific type of packets for each of the plurality of channels.

12. The system of claim 10, wherein the client agent passively monitors transmissions of the first wireless network interface and collects one or more of retransmission rate, radio traffic volume, and modulation and coding stream data for the first wireless network interface.

13. The system of claim 1, wherein the network testing device is stationary and location information for the network testing device is provided to the client agent by the test configuration server, and wherein location information is included by the client agent in the test results sent to the central wireless testing server.

14. The system of claim 1, wherein the location of the network testing device is determined dynamically by the client agent using wireless signal characteristics.

15. The system of claim 1, wherein the client agent scans a plurality of accessible wireless access points and their signal levels and submits the resulting data to the central testing server, and wherein the central testing server receives wireless access point signal quality data from a plurality of client agents and determines, based on the received data, that a specific wireless access point is offline.

16. The system of claim 1, wherein the client agent performs an active test using a first wireless access point, wherein test traffic injected during the active test comprises a virtual local area network identifier to which the injected test traffic is to be routed outside the wireless network.

17. The system of claim 1, wherein the client agent monitors wireless network conditions, recording at least a wireless access point used and its signal strength, a plurality of neighboring wireless access points and their respective signal strengths, and location information pertaining to the network testing device.

18. the system of claim 17, wherein the client agent receives test instructions from the central wireless testing server that conditionally trigger a test in the presence of defined conditions within the recorded data.

19. The system of claim 1, wherein the client agent detects, using the first wireless network interface, dynamic frequency selection events and reports them.

20. The system of claim 19, wherein a dynamic frequency selection event comprises either detection of a radar by the first wireless network interface of the network testing device or receipt of a message from a wireless access point reporting that the wireless access point detected a radar.
